(19) United States
(12) Patent Application Publication
(10) Pub. No.: US 2008/0118626 A1
(43) Pub. Date: May 22, 2008

(54) Solvent Extracted Corn

(75) Inventors: Paul J. McWilliams, Racine, WI (US); Jennifer L. G. van de Ligt, Brooklyn Park, MN (US); Carlos Ibanez Cerda, Elk River, MN (US); Mark D. Newcomb, Independence, MN (US); Kevin J. Touchette, Princeton, MN (US); Joel Ingvalson, Minneapolis, MN (US); Toby J. Strom, Oskaloosa, IA (US); Michael Van Houten, Carmel, IN (US); Brian Wheeler, Martinsville, IN (US)

Correspondence Address: SENNIGER POWERS LLP, ONE METROPOLITAN SQUARE, 16TH FLOOR, ST LOUIS, MO, 63102, US

(73) Assignees: RENESSEN LLC, Creve Coeur, MO (US); CAN TECHNOLOGIES, INC., Minnetonka, MN (US); CARGILL, INC., Wayzata, MN (US)

(21) Appl. No.: 11/940,754

(22) Filed: Nov. 15, 2007

Related U.S. Application Data
(60) Provisional application No. 60/866,160, filed on Nov. 16, 2006.

(51) Int. Cl. A23D 7/02; A23L 1/10; A23K 1/14

(52) U.S. Cl. 426/623; 426/618; 426/417

(57) ABSTRACT

An improved extracted corn composition having an oil concentration of less than about 1.7 wt % (on an anhydrous basis) and containing high concentrations of protein and essential amino acids is provided. The composition has a nutritional profile advantageous for use as an animal feed ingredient. Also provided are processes for the preparation of the extracted corn composition; feed rations incorporating the extracted corn composition; and methods for the preparation of such feed rations.

This application is a non-provisional of U.S. Provisional Application No. 60/866,160 (filed Nov. 16, 2006).

### BACKGROUND OF THE INVENTION

1. Field of the Invention

The present invention generally relates to a solvent extracted corn composition (sometimes referred to as “extracted corn meal”) having low oil concentration and a nutritional profile advantageous for use as an animal feed ingredient; a process for the preparation of the extracted corn composition; feed rations incorporating the extracted corn composition; and to methods for the preparation of such feed rations.

2. Background of the Invention

Corn, Zea mays, is grown for many reasons including its use in food and industrial applications. Corn oil and corn meal are two of many useful products derived from corn.

Commercial processing plants utilizing conventional methods for extracting corn oil from whole corn kernels first separate the corn seed into its component parts (pericarp, tip cap, germ and endosperm) by wet or dry milling. Oil is then extracted from the corn germ fraction either by pressing the germ to remove the oil or by flaking the germ and extracting the oil with a solvent. In both processes, oil extraction is inefficient.

In U.S. Pat. No. 6,388,110, Ulrich et al. describe a process for extracting corn oil from corn kernels having a total oil content in excess of 8 weight percent. The process comprises flaking the kernels and solvent extraction of the oil from the flaked kernels.

In WO 05/108533, Van Houten, et al. disclose a corn oil extraction process wherein corn kernels having a moisture content of about 8 wt. % to about 22 wt. % are fractionated to produce a high oil corn fraction and a low oil corn fraction. Corn oil is solvent extracted from the LOF, leaving a solvent extracted high oil fraction product which, in one embodiment, may then be used as an ethanol fermentation feedstock or, in another embodiment, combined with other ingredients and used as a feed or food product for swine, poultry, cattle, pets or human. Prior to extraction, but subsequent to fractionation, the high oil fraction is optionally cracked, optionally conditioned with heat and/or moisture, and expanded with steam to produce an expandette (sometimes referred to as a “collet”).

Although the process described in WO 05/108533 is useful for the preparation of corn oil and solvent extracted corn, a need exists for a process that has improved oil extraction efficiency and a process that generates solvent extracted corn having improved nutritional characteristics such as low oil, and high protein and amino acid concentration.

### SUMMARY OF THE INVENTION

The present invention provides a solvent extracted corn composition having low oil content and improved essential amino acid and protein content, and methods for formulating animal feed rations from the solvent extracted corn composition. Also provided are improved processes for the preparation of solvent extracted corn composition.

One aspect of the present invention is directed to an extracted corn fraction composition prepared from corn kernels. The extracted corn fraction comprises, on an anhydrous basis, starch, about 9 to about 25 weight percent protein, about 12 to about 24 weight percent neutral detergent fiber, and less than 1.7 weight percent oil, the weight ratio of protein to starch being about 0.15 to about 0.8.

Another aspect of the present invention is directed to a corn expandette prepared from corn kernels. The expandette comprises starch, protein and oil, wherein the expandettes have a packed density of from about 0.3 to about 0.5 grams per milliliter.

Another aspect of the present invention is directed to a process for preparing corn expandettes. The process comprises fractionating corn kernels into a high oil fraction and a low oil fraction, the high oil fraction having an oil content greater than the corn kernels and the low oil fraction having an oil content less than the corn kernels. The high oil fraction is separated from the low oil fraction, and the high oil fraction is expanded with steam in an expander to produce expandettes. The steam feed rate to the expander is from about 0.042 to about 0.075 kilograms of steam per kg of high oil fraction and the temperature of the high oil fraction in the expander is from about 140° C. to about 180° C.

Still another aspect of the present invention is directed to a method for formulating an animal food ration. The method comprises determining the lysine and protein requirements of the animal and then identifying a plurality of natural and/or synthetic feed ingredients and the available lysine and protein of each of the ingredients wherein one of the ingredients is a fractionated corn portion having a total lysine concentration greater than yellow number two corn and a ratio of total lysine to total protein of from about 0.015 to about 0.06. The ration is formulated from the identified ingredients to meet the determined lysine requirements of the animal.

Other objects and features will be in part apparent and in part pointed out hereinafter.

### BRIEF DESCRIPTION OF THE DRAWINGS

Corresponding reference characters indicate corresponding parts throughout the drawings.

FIG. 1 is a schematic flow chart of a prior art process for the separation of corn germ and endosperm.

FIG. 2 is a schematic flow chart of one embodiment of the present invention.

FIG. 3 is a schematic flow chart of one embodiment of a two stage fractionation process of the present invention.

FIG. 4 is a schematic flow chart of one embodiment of a corn cracking process of the present invention.

FIG. 5 is a schematic flow chart of an alternative embodiment of the present invention.

### DETAILED DESCRIPTION OF THE INVENTION

The present invention is directed to an improved process for the preparation of an extracted corn meal composition from various corn sources which enables a greater percentage of the corn oil to be extracted, and produces an extracted corn meal product having a desirable nutrient profile suitable for the preparation of animal feeds.

In general, the process of the present invention comprises a fractionation step, an expansion step, and a solvent extraction step. In the fractionation step, the corn is fractionated into portions comprising a high oil fraction (“HOF”) and a low oil fraction (“LOF”) as described, for example, in WO 05/108533. Fractionation equipment used to create the HOF produces a stream that can be characterized as a powder or fine meal. This meal is generally not suitable as feed to a commercial extractor due to the risk of the fine meal plugging up the extraction equipment and/or the inability to drain solvent through the meal bed. The high oil fraction is treated with steam in an expander to produce an expanded structure suitable for oil extraction (an expandette) and the corn oil contained therein is then solvent extracted from the expandettes to produce a solvent extracted high oil fraction (“SEHOF”).

In one embodiment, the improved process operating conditions of the present invention include, but are not limited to, one or more of the following: (i) HOF moisture and temperature conditioning prior to expansion, (ii) expansion steam addition rate, (iii) expansion temperature, (iv) expansion pressure, (v) expandette cooling prior to extraction, and (vi) combinations thereof, enable the preparation of SEHOF having low oil content and having favorable nutritional characteristics as compared to the starting corn, such as elevated lysine and tryptophan content, a high ratio of oleic to linoleic acid and reduced xanthophyll content.

Typical starting material for the extraction process of the present invention may be whole kernel corn seed or grain harvested from a wide variety of corn plants. Suitable corn types include: conventional corn (e.g., yellow number 2); flint corn; popcorn; flour corn; dent corn; sweet corn; hybrids; inbreds; transgenic or genetically modified plants selected from high oil, hard endosperm, nutritional density, high protein, high starch, waxy corn and white corn; or combinations thereof.

Botanically, a corn kernel is termed a caryposis and is a dry, one seeded, nut-like berry in which the fruit coat and the seed are fused to form a single grain. Mature kernels are composed of four major parts: pericarp (hull or bran), tip cap, germ (embryo) and endosperm.

The pericarp is the hard water-impermeable protective outer covering of the corn kernel. It comprises the mature ovary wall that is beneath the cuticle and it also comprises the outer cell layers down to the seed coat. The pericarp is high in non-starch-polysaccharides (e.g., fibers), such as cellulose, pentosans and hemicellulose. The site where the kernel is joined to the cob is a continuation of the pericarp and is termed the tip cap. The tip cap comprises a loose and spongy parenchyma.

The germ contains the essential genetic information, enzymes, vitamins and minerals required by the kernel to grow into a corn plant. The germ is characterized by a high oil content and is rich in crude proteins, sugars and ash constituents. It comprises two major components, the scutellum and the embryonic axis. During germination, the embryonic axis grows into a seedling. The function of the scutellum is digestion and absorption of the starch from the endosperm. The scutellum makes up about 90% by weight of the germ and is a site for storing nutrients mobilized during germination.

The endosperm comprises the major portion, by weight, of the corn kernel. In some corn varieties, the endosperm is up to about 85 weight percent (“wt %”) (on an anhydrous basis) of the corn kernel. The endosperm is rich in starch, carotenoids (e.g., carotenes), xanthophylls (e.g., lutein and zeaxanthin) and tocotrienols, and is lower in protein, oil and ash than the germ.

In one embodiment, the corn grain used in the practice of the present invention is a high oil corn comprising, on a dry matter (i.e., anhydrous) basis, at least about 6 wt % or greater oil. However, conventional yellow corn, having an oil content of, for example, about 3 wt % to about 6 wt % is also suitable. High oil corn is commercially available, for example, from Cargill Inc. (Minneapolis, Minn., USA), Monsanto, (St. Louis, Mo., USA), Pfister Hybrid Corn Co. (El Paso, Ill., USA), Wyffels Hybrids Inc. (Geneseo, Ill., USA), Galilee Seeds Research and Development (Rosh Pina, Israel) and DuPont Specialty Grains (Johnston, Iowa, USA). Other suitable high oil corn includes the corn populations known as Illinois High Oil (IHO) and Alexander High Oil (Alexo), samples of which are available from or through the University of Illinois Maize Genetics Cooperation Stock Center (Urbana, Ill., USA). Examples of high oil corn include DuPont OPTIMUM™; AgriGold hybrids A6453TC and A6490; Monsanto DK621TC; Asgrow hybrids 748TC and RX730TC; Golden Harvest H9257; Burrus 560 TC3; Croplan hybrids 6607ED and 6611ED; TopCross® blends available from Pfister as hybrids SK2550-19, SK2650-19, SK2652-19, SK2680-19, SK3001-19 and SK3049-19; and Pioneer 34B25. Methods for developing corn inbreds, hybrids, transgenic species and populations that generate corn plants producing grain having elevated oil concentrations are known and described in the art. See, for example, Lambert, Specialty Corn, CRC Press Inc., Boca Raton, Fla., USA, pages 123-145 (1994) and United States Patent Application Publication No. 2003/0182697. High oil corn grain comprises, on an anhydrous basis, from about 6 wt % to up to about 22 wt % oil, typically from about 6 wt % to about 18 wt % oil. Oil content can be measured by any of a number of methods known in the art such as by using American Oil and Chemical Society Official Method Ba 3-38 (see 5th edition, March 1998) or by using a near infrared (NIR) oil detector.

In another embodiment, (a) corn varieties having traits such as hard endosperm, waxy, white, nutritionally dense, high protein or high starch, (b) corn varieties having combinations of traits selected from two or more of high oil, hard endosperm, waxy, white, nutritionally dense, high protein and high starch, or (c) a mixture of two or more corn varieties having traits selected from high oil, hard endosperm, waxy, white, nutritionally dense, high protein and/or high starch can be processed according to the process of the present invention. Hard endosperm varieties include, for example, AgriGold hybrids A6427 and A6490, QTIC QC9664, LG Seeds C7847, Pioneer hybrids 34K77 and 33P66, Burrus 442, LG Seed LG2587, Horizon Genetics 7460CL, and Trisler T5313. Waxy varieties include, for example, Novartis N4342, Pioneer hybrids 34H98 and 33A63, and DeKalb 624WX. White varieties include, for example, Pioneer hybrids 34P93 and 32Y52, Asgrow 776W, Trisler T4214, and AgriGold 6530. Nutritionally dense varieties include, for example, Adler 4100, Diener 105, Lewis ND5000, Growmark 6581ND, Beck EX1924, Bird hybrids ND70 and ND74, Croplan hybrids TR1049ND, E557, E560 and E565, Exseed Nutridense® hybrids 5109ND and 5110ND, Mycogen hybrids 2654 and 2655, Seed Consultants 11N00, Seedway 618HOC, and Wellman hybrids WIN 109 and WIN 111. An example of a high protein variety is Diener 108S and an example of a high starch variety is Novartis N59-Q9.

In the fractionation step (also termed degermination), corn is separated into components comprising germ (a high oil fraction) and endosperm (a low oil and starch rich fraction). In general, any fractionation process known to those skilled in the art that generates a germ stream having an average particle size range of from about 500 to about 2000 microns, preferably about 1000 microns, is suitable for the practice of the present invention.

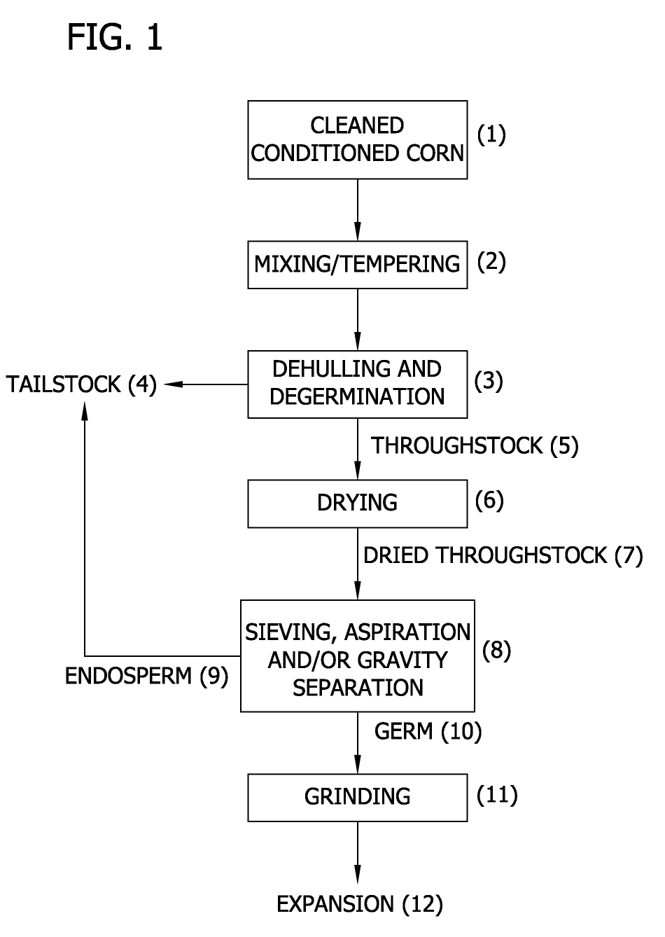

In one fractionation embodiment, corn germ can be produced by a prior art process for the preparation of dry milled corn germ as depicted in FIG. 1. In that process, cleaned and conditioned corn (1) (preferably hard endosperm yellow or white corn) is fed from storage to a mixer for tempering (2). Conditioning and tempering generally (i) favors separation of the bran coat from the endosperm, (ii) facilitates the separation of the germ from the endosperm by making it soft and elastic thereby preventing it from breaking apart during degermination, (iii) reduces the amount of flour produced during degermination, and (iv) results in a high yield of high starch, low oil, low fiber endosperm.

Referring again to FIG. 1, after tempering, the corn kernels are fed into a dehulling and degermination device (3). Examples of such devices include an impact or conical maize degerminator manufactured by Ocrim S.p.A. (Cremona, Italy), a vertical maize degerming machine (VBF) manufactured by Satake Corporation, and a Beall degerminator (Beall Degerminator Company) where impact, abrasion, or shearing action separates the endosperm fraction, termed tailstock (4), from the germ and pericarp fractions, termed throughstock (5).

Recovery of the various fractions is done according to their physical characteristics, for example, particle size and density. Typical separation methods include sieving, aspiration and/or fluidized bed air classification. The coarsest fraction contains large, medium and small particles of endosperm, as measured by their collection on screens ranging in size from 3.5 wire to 14.0 wire. The endosperm (tailstock) is essentially free of germ, and is typically further aspirated to remove bran and dust. The throughstock is smaller in size and lighter in weight than tailstock. It should be noted that the separation and recovery of endosperm from the dehulling and degermination devices is rarely 100 percent, and portions of broken endosperm and endosperm that are loosely attached to the germ (mostly in the form of meal or flour) end up being present in the throughstock.

The throughstock absorbs most of the water during the tempering process. The moisture content of the throughstock is typically lowered by drying (6) from 22 to 25 percent to between 12 and 15 percent to produce dried throughstock (7).

Dried throughstock (7) is subjected to sieving, aspiration and gravity separation (8) to remove additional quantities of endosperm (9) and generate a germ stream (10) that typically further comprises fine particles of residual endosperm and fiber. A fiber stream can be optionally removed from the dried throughstock stream (7) in the sieving, aspiration and gravity separation (8) operation to generate a germ stream (10) that is essentially free of fiber.

The germ or the germ and fiber portion of the throughstock may then be ground to a particle size of from about 500 to about 2000 microns, preferably about 1000 microns. That powder germ may then feed to the expander the expansion process described below.

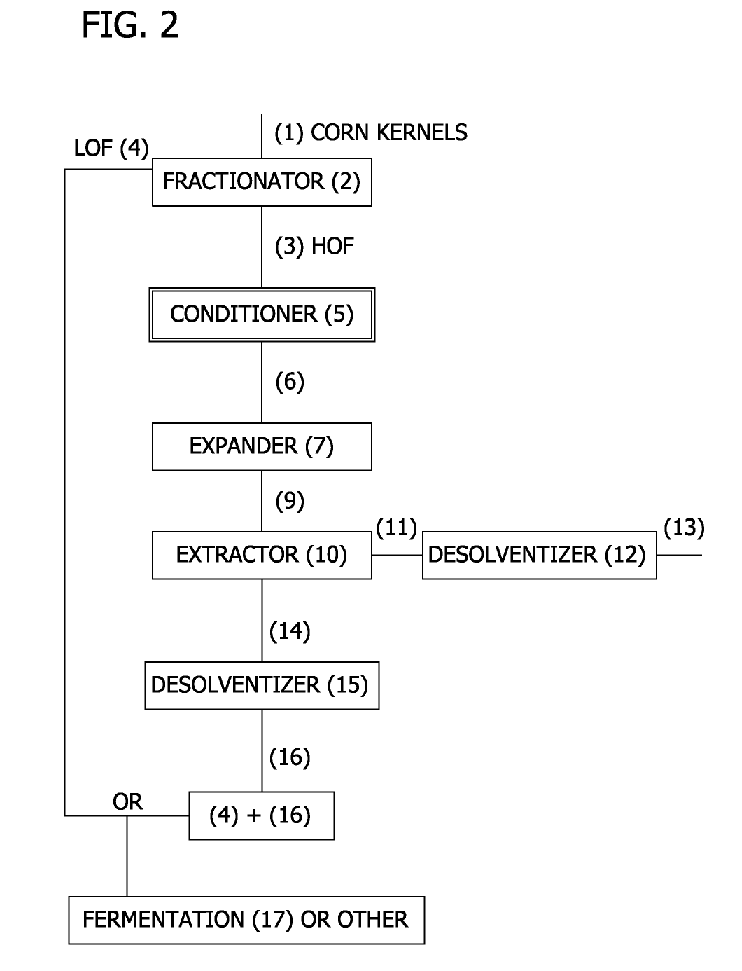

In one preferred embodiment of the present invention, depicted in FIG. 2, the whole corn kernels (1) are conveyed to a fractionating apparatus (2) such as a Buhler-L apparatus (Buhler GmbH, Germany), a Satake VCW debranning machine (Satake USA, Houston, Tex.), or other equipment wherein the kernels are contacted with an abrasive device to separate a portion of the hull and the germ component from the remainder of the corn material, generally comprising the endosperm. As used herein, the germ component refers to a portion of the corn material containing the corn germ, fractions of corn germ, components of germ, or oil bodies. Where a screen is used as the abrasive device, a portion of the hull and germ component pass through the screen(s) and form the HOF (3). The HOF particle size is generally predominantly less than a size US Number 18 mesh sieve having a 1.00 mm opening, as defined in the American Standards for Testing and Materials 11 (ASTME-11-61) specifications. The material left on the screen(s) comprises the LOF (4) and some germ component. The HOF has an oil concentration greater than that of the corn kernels and the LOF has an oil concentration less than that of the corn kernels. HOF generally has an oil concentration of at least about 5%, 8%, 10%, 12%, 14%, 16%, 20%, or even 25% by weight on an anhydrous basis. HOF prepared from yellow number 2 corn, or other non-high oil varieties, typically has an oil content of less than about 10.5% by weight on an anhydrous basis and HOF prepared from high oil corn typically has an oil content of greater than about 10.5% by weight on an anhydrous basis. LOF generally has an oil concentration of less than about 6%, 3%, 1% or even 0.5% by weight on an anhydrous basis. Fractionation apparatus operating parameters such as, for example, screen size, feed rate, mill speed, air flow through the apparatus, clearance between the screen and the rotating component (e.g., wheel, disc, rotor, roller or contact points such as nips), and combinations thereof, can be varied affect the extent of corn kernel abrasion and the ratio of LOF to HOF. The ratio of LOF to HOF is preferably from about 50:50 to about 90:10, for example, about 55:45, about 60:40, about 65:35, about 70:30 or about 75:25.

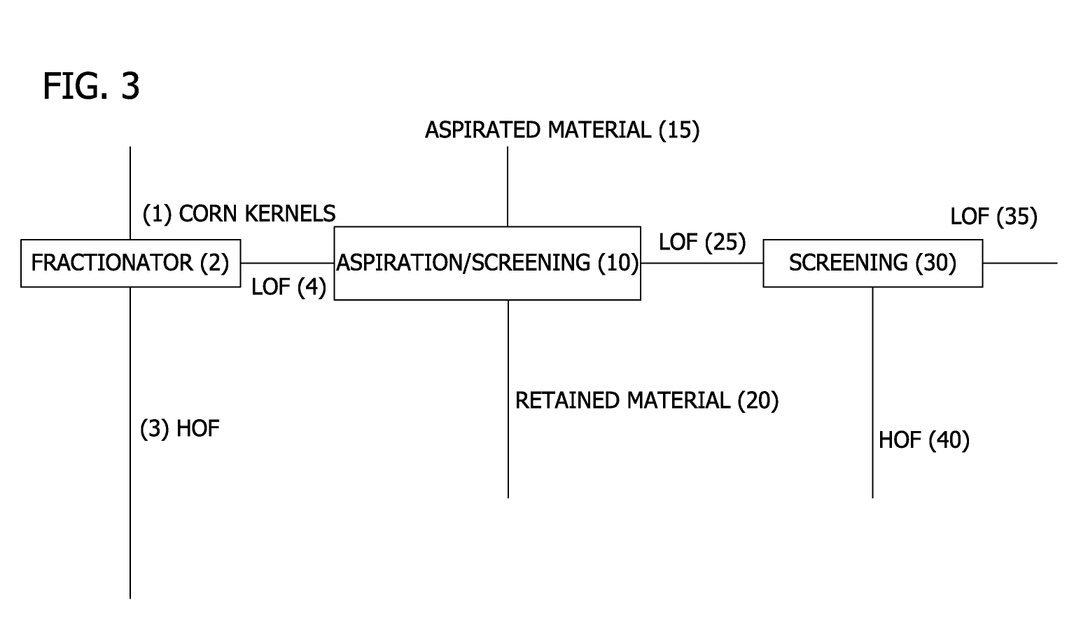

In another preferred fractionation embodiment, LOF is aspirated followed by a second fractionation step comprising one or two screening steps. Referring to FIG. 3, corn kernels (1) are conveyed into a fractionator (2). The resulting LOF (4) is aspirated and then screened (10). Aspiration methods are known in the art. Aspirated material typically comprises about 1 to about 2 percent by weight of the corn kernel (1) weight. Aspirated material (15) generally has a high oil content as compared to HOF and is typically combined with the HOF stream (3). Screening methods are likewise known in the art. The screening step (10) is preferably done using a vibrating screening and shaking device such as that manufactured by Rotex (Rotex, Inc., Cincinnati, Ohio, USA, Model No. 201GP) or Buhler (Buhler GmBH, Germany, MPAD Pansifter). A screen having an opening of from about 4000 micron to about 8000 micron, from about 5000 micron to about 7000 micron, for example about 6000 micron, is preferred. The coarse material retained on top of the screen (20) can be recycled and combined with the fractionator feed (2). The material passing through the screen is LOF (25) and can be combined with a finished LOF stream or can be processed in a second screening step (30) using a fine screen having an opening of from about 800 to about 1600 micron. The HOF (40) material passing through the second screen is typically combined with HOF (3) and the material retained on the screen is LOF (35).

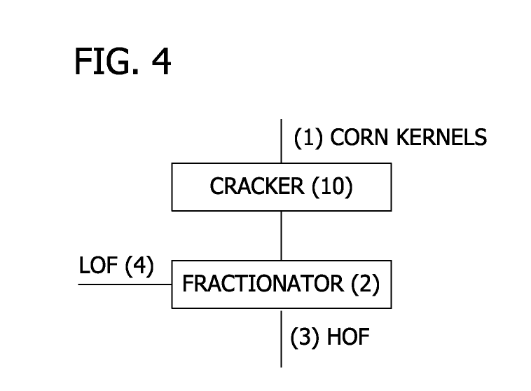

In another fractionation embodiment, as depicted in FIG. 4, corn kernels (1) are fed to a cracking apparatus (10) prior to entering the fractionating apparatus (2). The kernels can be cracked by methods known to those skilled in the art such as those described, for example, in Watson, S. A. and Ramstad, P. E., Corn: Chemistry and Technology, Chapter 11, American Association of Cereal Chemists, Inc. St. Paul, Minn., USA (1987)

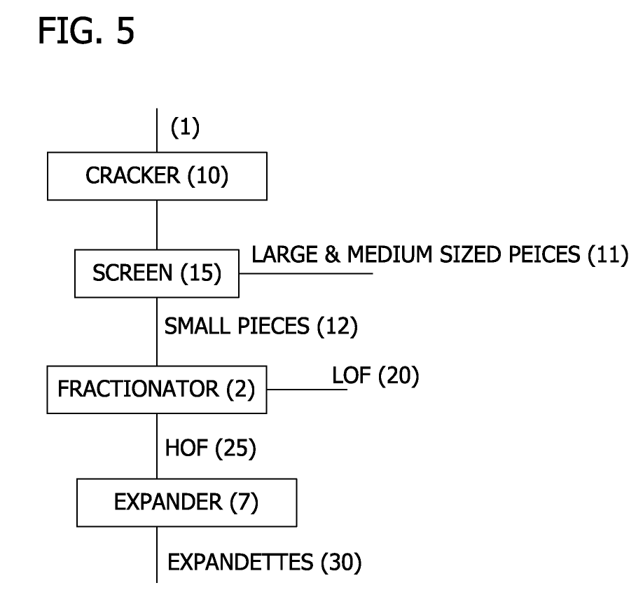

In an alternative fractionation embodiment, as depicted in FIG. 5, corn kernels (1) are fed to a cracking apparatus (10) to produce large and medium sized cracked corn pieces (11) that are separated from small cracked corn pieces (12) by any suitable method, such as screening and/or aspiration (15). In one embodiment, a Rotex screen with a 4 mesh mill grade having 5.46 mm holes (Rotex, Inc., Cincinnati, Ohio, USA, Model No. 201GP) is used.

The large and medium sized cracked corn pieces (11) can be optionally ground in a mill to produce ground cracked corn or flaked in a flaker to produce flaked cracked corn. An example of a suitable mill is a Fitzmill comminuter (Fitzpatrick Company, Elmhurst, Ill., USA) fitted with a 0.6 cm (¼ inch) screen. Useful commercial-scale oilseed flakers can be obtained, for example, from French Oil Mill Machinery Company (Piqua, Ohio, USA), Roskamp Champion (Waterloo, Iowa, USA), Buhler AG (Germany), Bauermeister, Inc. (Memphis, Tenn., USA) and Crown Iron Works (Minneapolis, Minn., USA). After milling or flaking, the material can be optionally added to the HOF stream (35) feeding the expander (7).

The small sized pieces of cracked corn (12) that pass through the screen in the screening process generally have an oil content less than the whole corn kernels from which is was produced. It can be optionally aspirated prior to fractionation (2) to remove fines, generally comprising bran.

Stream (12) is fed to the fractionator (2) which generates an LOF stream (20) and a HOF stream (25). The HOF stream (25) is optionally conditioned and is then fed to the expander (7) to produce expandettes suitable for oil extraction.

The LOF, containing the endosperm component, is higher in starch content than HOF. The LOF fraction is suitable for use as starting material for fermentation processes for the preparation of, for example, ethanol or butanol (as depicted in FIG. 2, (17)). LOF can also be used as a feedstock for production of carboxylic acids, amino acids, proteins and plastics, as well as cosmetics and food applications. In one embodiment, prior to fermentation, the LOF is further processed to form a corn protein fraction and a starch fraction. The starch fraction is then used as a feed material in fermentation processes or for the production of food and/or industrial starches. In another embodiment depicted in FIG. 2, the LOF (4) fraction can be combined with SEHOF (16) for use as an animal feed.

In addition to tempering corn before cracking, corn may optionally be tempered prior to abrasive-type fractionation described above. Tempering generally increases the differential hardness between the germ component and the remainder of the corn material and facilitates separation. In tempering, the corn material is heated directly or indirectly and/or water is added. Any tempering method known in the art is acceptable, including, but not limited to, spraying water or sparging steam.

As described above and depicted in FIG. 2, HOF or germ (collectively termed HOF) can be conditioned (5) prior to expansion to generate expandettes. It has been discovered that expandettes prepared from low moisture HOF can exhibit reduced porosity as compared to higher moisture material and can cause oil extraction processing problems. It has further been discovered that feed having a moisture content of less than about 12 wt % and/or feed having an oil content of less than about 9 wt % (about 10.5 wt % on an anhydrous basis) can adversely affect expander performance. Such HOF can bridge in the expander; is typically of insufficient flowability to allow even mixing thereby creating inhomogeneous steam addition resulting in “cold” and “hot” spots and uneven heating; can cause expander pressure fluctuations and gradients; is difficult to extrude; and/or can cause excessive shear that can result in expander wear and maintenance problems. In the case of HOF having an oil content of less than about 9 percent by weight (about 10.5% on an anhydrous basis), such as HOF prepared from yellow number 2 corn, it has been observed that certain rheological properties can cause the expander to plug thereby resulting in reduced throughput. Without being bound to any particular theory, it is believed that low oil content results in HOF having relatively low viscosity and increased flow properties under the expander pressure conditions of from about 26 bar to 35 bar, thereby causing leakage between the expander screw and the expander housing and causing HOF to backflow in the expander. Desired expander operating pressure therefore typically cannot be achieved and the expander plugs with material.

It has been discovered that temperature conditioning and/or moisture content adjustment improves expander operation when processing low oil and/or low moisture HOF.

For HOF having an oil content of less than about 10.5 wt % (anhydrous basis), it has been discovered that the rheological characteristics of HOF can be altered by adding steam to the conditioner. The combination of heat and water (supplied from condensed steam) causes the HOF to assume a viscous dough-like consistency thereby preventing it from backflowing in the expander. Preferred expander operating pressure and throughput can thereby be attained. On a kg of steam per kg of HOF basis, a steam rate of from about 0.03 to about 0.05 to the conditioner is preferred, more preferably from about 0.035 to about 0.045. Generally, all of the steam condenses in the HOF resulting in an HOF moisture content increase of from about 3% to about 5% by weight. The steam can be saturated with up to about 10% water. A conditioned HOF temperature of from about 60° C. to about 80° C. is preferred.

In the case HOF having low moisture, the expander feed moisture content can be adjusted to greater than about 12% by weight prior to expander treatment. In one embodiment, that moisture content can be achieved by heating the HOF with steam to a temperature of 80° C., 75° C., 70° C., 65° C. or even 60° C. During heating, steam condenses in the HOF thereby increasing the water content from about 3% to about 5% by weight. The steam can be saturated with up to about 10% water. A water content of greater than about 12% by weight is preferred, with a range of from about 12% to about 16% preferred.

An example of a suitable conditioner is a Buhler Model DPSD homogenizer (Buhler GmBH, Germany).

In one alternative embodiment, the HOF conditioner is integral with the expander barrel thereby forming an extended barrel comprising a first stage HOF conditioning zone, a second stage expansion zone. For example an expander having an extended barrel and extended internal screw can be utilized. The expander barrel section where the HOF is fed forms the first zone where conditioning steam is added to achieve the desired temperature range of from about 60° C. to about 80° C. and the desired moisture content of greater than about 12 wt %. The conditioned HOF then passes into the second stage expansion zone where sufficient steam is added to increase the temperature to the preferred range of from about 140° C. to about 180° C. as described more fully below.

As depicted in FIG. 2, HOF feed (6) is treated in an expander (7) under high shear, temperature and pressure conditions to generate expandettes (9) having unique characteristics of porosity, density, size, shape and/or hardness that enable the preparation of SEHOF having an oil content of less than 1.7 wt % on an anhydrous basis.

Expansion generally involves four stages. In the first stage, a conveyor, such as a screw conveyor, transfers HOF feed material (6) into the expander (7) at a predetermined rate selected to provide the desired residence time in the extruder treatment zone. In the second stage, the adjusted HOF material enters the treatment zone where it is heated with steam under high pressure, temperature and shear conditions. In the third stage, the hot, pressurized, HOF material is extruded out of the treatment zone through die head slots and into an expansion zone characterized by reduced (e.g., ambient) temperature and pressure conditions. In the expansion zone, the pressure of the extruded HOF drops. The pressure release causes the volume of the treated HOF to expand resulting in rapid evaporation, or flashing, of a portion of the contained water with concomitant temperature decrease. In a fourth stage, the expandettes are cut to length by a rotating knife assembly thereby fixing the expandette size. The amount of steam added to the HOF can affect the quality of the collet. The quality of the collet will in turn affect the ability to extract the oil from the collets. An example of a suitable expander is the Buhler Condex DFEA Expander Model 220 (Buhler GmBH, Germany).

In general, any positive displacement method of feeding the HOF to the expander is suitable, with screw feeders generally preferred. The feed rate is generally selected and controlled in order to achieve the desired residence time in the expander, with the absolute rate in kilograms per hour primarily being a function of expander barrel volume and feed rate. An expander barrel residence time of less than about 10 seconds is preferred, for example 8, 5 or 1 second.

Shear is generated as the HOF contacts expander screw conveyors, paddles, interrupter bars, and the like, against the back pressure generated at the expander discharge. HOF shear can be controlled through the selective use of design elements such as reverse screws, interrupter bars (optionally including paddles rotating between the interrupter bars), stationary breaker bolts, pressure rings, air locks, and combinations thereof. Pressure and HOF rheological characteristics, such as viscosity, also affect the amount of shear, with high pressure and high viscosity resulting in greater shear. HOF viscosity is a partially a function of particle size and moisture content.

Barrel pressure can be attained and controlled by any of numerous methods and expander designs known in the art. In one method, in a pressure control loop, an annular ring with matching cone is coupled to a hydraulic system that moves the cone in response to internal barrel pressure as compared to a predetermined pressure set point in order to produce a variable orifice size and thereby maintain a relatively constant internal pressure. In another method, the hot, pressurized, HOF is passed through a die plate having holes to allow material to pass through as an extrudate. In a pressure control loop for that method, the feed rate is changed in response to internal barrel pressure as compared to a predetermined pressure set point in order to maintain a relatively constant internal pressure. An expander pressure of less than 35 bar is preferred. Pressure can suitably range from about 26 bar to 35 bar, from about 27 bar to about 34 bar, from about 28 bar to about 33 bar, from about 28 bar to about 32 bar, or even from about 29 bar to about 31 bar.

Barrel temperature is achieved by a combination of heating resulting from friction and direct steam injection into the expander barrel. Steam addition generally raises HOF temperature of about 100° C. and the remainder of the temperature is generated by mechanical energy (e.g., shear and friction). In one process option, the HOF can be directly heated by injecting steam into the expander barrel at one or more locations. In one direct heating embodiment, the steam is substantially uniformly injected through one or more nozzles located proximate to the expander barrel discharge in order to minimize HOF high temperature exposure time and steam usage. An expander temperature range of from about 140° C. to about 180° C. is preferred. Where the HOF has an oil content of less than about 9% by weight (10.5% on an anhydrous basis), a temperature range of from about 140° C. to about 170° C. is more preferred, still more preferably from about 140° C. to about 160° C. Where the HOF has an oil content of greater than about 10.5% (anhydrous basis) by weight, a temperature range of from, from about 150° C. to about 165° C. is more preferred, still more preferably from about 155° C. to about 165° C.

The expander temperature is typically achieved with a total steam input to the conditioner and the expander of from about 0.042 to about 0.075 kg of steam per kg of HOF. The steam can be saturated up to about 10% water.

For HOF that has been conditioned with steam, a steam feed rate to the expander of from about 0 to about 0.03 kg of steam per kg of HOF is preferred, in particular, 0, 0.001, 0.005, 0.01, 0.015, 0.02, 0.025 or 0.03 kg of steam per kg of HOF.

For HOF having an oil content of greater than about 9% by weight (10.5% on an anhydrous basis), and that has not been conditioned with steam, a steam rate to the expander barrel of from about 0.042 to about 0.075 kg of steam per kg of HOF is preferred, more preferably from about 0.042 to about 0.06 kg of steam per kg of HOF, for example, 0.042, 0.043, 0.044, 0.045, 0.046, 0.047, 0.048, 0.049, 0.05, 0.051, 0.052, 0.053, 0.054, 0.055, 0.056, 0.057, 0.058, 0.06, 0.065, 0.070 or even 0.075 kg of steam per kg of HOF. In one embodiment, high oil content HOF can be optionally conditioned with about 0.001 to about 0.02 kg of steam per kg of HOF and the remainder of the steam is added to the expander.

In one embodiment, HOF prepared from high oil corn is expanded at a steam feed rate to the expander barrel of from about 0.042 to about 0.06 kg of steam per kg of HOF, the expander die pressure is regulated from about 27 bar to about 33 bar, and the expander barrel temperature is regulated from about 155° C. to about 165° C.

In another embodiment, HOF prepared from yellow number 2 corn is conditioned with from about 0.03 to about 0.05 kg steam per kg HOF and is expanded at a steam feed rate to the expander barrel calculated to provide a total steam input to the conditioner and expander of from about 0.042 to about 0.06 kg of steam per kg of HOF. For example the steam feed rate to conditioner is from about 0.03 to about 0.05 kg steam per kg HOF and the expander steam feed rate is from about 0.001 to about 0.03 kg of steam per kg of HOF. The expander die pressure is regulated from about 27 bar to about 33 bar, and the expander barrel temperature is regulated from about 140° C. to about 180° C. For

In one alternative embodiment, HOF conditioning is done in the expander using an extended expander barrel as described above. The conditioner is integral with the expander barrel thereby forming an extended barrel comprising a first stage feed conditioning zone, a second stage expander treatment zone (i.e., expansion), a third stage extrusion zone and a fourth stage expandette cutting zone. In the conditioning zone, HOF can be adjusted to a preferred moisture content of from about 12% to about 16% at a preferred temperature of from about 60° C. to about 80° C. using a preferred steam feed rate of from about 0.03 to about 0.05 kg of steam per kg of HOF as described above.

Advantageously, HOF heat treatment in the preferred temperature range of from about 140° C. to about 180° C. yields expandettes having exceptional hardness and durability with a minimal amount of fines. Under one theory, and without being bound to any particular theory, it is believed that the high temperature HOF expansion of the present invention results in increased starch gelatinization and gluten thermosetting that yields the hard and durable expandettes. It has further been discovered that the operating temperature and pressure ranges of the present invention increases the degree of inactivation (i.e., kill rate) of harmful pathogens such as Salmonella that commonly infect animal feed, and also renders unproductive any contained seeds, such as wild oats.

In the third stage, expandettes are formed by extruding the heated and pressurized HOF through a slotted die to produce an extrudate that is subsequently expanded and cooled by depressurization upon exposure to reduced (e.g., ambient) pressure and temperature conditions. The slots can be of any shape selected to produce expandettes having conformational and morphological characteristics selected to yield a solvent extraction bed providing suitable extraction efficiency. It has been discovered that HOF oil content influences the die slot size requirements. For HOF prepared from high oil corn, small die slot sizes are preferred, for example, 20 mm, 18 mm, 16 mm, 14 mm, 12 mm, 10 mm, 8 mm or even 6 mm. In one embodiment, a die slot size of 8 mm is used. For HOF prepared from yellow number 2 corn, larger die slot sizes are preferred, for example, about 20 mm, 24 mm, 28 mm, 32 mm, 36 mm, 40 mm, 44 mm, 48 mm, 52 mm, 56 mm or about 60 mm. In one embodiment, a die slot size of 24 mm is used. In another embodiment, a die slot size of 52 mm is used.

In the fourth stage, the expandettes are cut to length. The size (volume) and shape of the expandettes and the amount of fine material in the expandettes affects extraction efficiency. Expandette size is generally controlled by a combination of the extruder plate size (i.e., slot surface area), the number of knife blades on the rotating knife assembly and the knife assembly rotation speed. Expandette size affects solvent extraction efficiency by a combination of surface area to volume ratio and formed expandette bed extraction permeability. Expandette size is typically not fixed and a range of expandette sizes are generally present. A representative sample of expandettes typically includes expandettes having average dimensions ranging from about 0.5 cm×0.5 cm to 0.5 cm to about 8 cm×4 cm×2 cm, but breakage results in a small percentage of fine material. Experimental analysis of a representative expandette sample indicated expandettes ranging in dimension from about 0.5 cm×0.5 cm×1 cm to about 3 cm×3 cm×1 cm, including up to about 5% fines having a size of less than 18 mesh. Further experimental analysis of a representative expandette sample indicated about 19% by number of expandettes having a size of about 2.5 cm×2.5 cm×1 cm, about 59% by number of expandettes having a size of about 1.3 cm×1.3 cm×1 cm, about 19% by number of expandettes having a size of less than about 1.3 cm×1.3 cm×1 cm, and less than about 3% fines having a size of less than 18 mesh. Preferably, expandette size and shape provide packed expandette beds having sufficient solvent hold-up characteristics that enable adequate expandette-solvent contact time required to achieve extraction efficiency sufficient to yield an extracted desolventized expandette oil concentration of less than about 1.7 wt % on an anhydrous basis. Problematically, large expandettes having low included fines content can create a relatively open extractor bed with poor solvent hold-up characteristics, resulting in an ineffective extraction. Conversely, small expandettes can result in an extractor bed having excessive solvent hold-up and resulting poor extraction efficiency.

In one preferred embodiment, the expandettes are dried to a moisture content of from about 9% to about 12% by weight, for example, about 10% by weight prior to solvent extraction and desolventization. In particular, it has been discovered that expandette moisture content in excess of about 12% by weight will result in a final moisture content of about 22% by weight (or more) after steam treatment in the desolventization operation resulting in expandette agglomerization. Over time, a large expandette mass can form that prevents operation of the desolventization and drying equipment requiring the equipment to be cleared of material. In general, expandette drying is done by passing air as a temperature of from about 50° C. to about 95° C., more preferably from about 52° C. to about 93° C. through an expandette bed. In one embodiment, air having a temperature of about 74° C. is passed through an expandette bed until the relative humidity of the outlet air is less than about 80% resulting in a HOF moisture content of from about 9% to about 12%. Expandette drying can be done in dryers known in the art. In one embodiment, an existing expandette cooler can be modified to add heat and air.

At the above described operating conditions, the expander will form the HOF into highly porous hard expandettes having a unique compositional make-up and which have excellent extraction characteristics in a conventional leach bed solvent extractor system as is used for vegetable oil extraction. It is believed that the expandettes of the present invention are more porous and have reduced density as compared to prior art expandettes thereby allowing higher amounts of oil to be extracted and increase extractor throughput. Porous expandettes allow solvent to drain more freely as compared to prior art expandettes thereby increasing desolventizing efficiency by reducing solvent carryover and energy requirements. In one embodiment, beds of expandettes of the present invention preferably have a bulk density of from about 0.3 g/cm³ to about 0.45 g/cm³, for example, 0.3, 0.35, 0.4 or even 0.45 g/cm³. In another embodiment, beds of expandettes of the present invention preferably have a packed density of from about 0.30 g/cm³ to about 0.50 g/cm³, more preferably from about 0.35 g/cm³ to about 0.45 g/cm³, for example, 0.3, 0.35, 0.4, 0.45 or even 0.5 g/cm³. In another embodiment, the expandettes preferably have a displacement density, as determined by the volume of light mineral oil (about 0.85 g/mL) displaced per gram of sample, of from about 1 to about 1.3 g sample/mL oil, more preferably from about 1 to about 1.29, from about 1 to about 1.28, from about 1 to about 1.27, from about 1 to about 1.26, or even about 1 to about 1.25 g sample/mL oil. In another embodiment, the expandettes preferably have durability as measured according to the method of McElhiney, Robert R. (ed.), Feed Manufacturing Technology III (1985) of from about 50% to about 90% expandette retention on a #6 mesh Tyler standard screen, from about 60% to about 90% retention, from about 70% to about 90% retention, from about 50% to about 80% retention, from about 60% to about 80% retention, or even from about 65% to about 75% retention on a #6_mesh Tyler standard screen.

### Extraction

As described in more detail in WO 05/108533, and as depicted in FIG. 2, expanded fractionated HOF (9) can be extracted with a solvent to generate an extracted corn meal. In one embodiment, expanded HOF (9) is subjected to a solvent extraction step to yield wet solvent extracted HOF (14) (“crude SEHOF”) and miscella (11). Solvent extraction of oil seeds is well known in the art. The extraction step can be accomplished by using any of a variety of immersion type or percolation type extractors. Generally, any device can be used that will contact the solvent with the oil bearing expandettes and allow for sufficient separation of the oil from the HOF, followed by sufficient separation of the miscella from the HOF is suitable for the practice of the present invention. Among the specific types of typical extractors are rotary bed extractors, deep bed extractors, carousel extractors, horizontal belt extractors, continuous loop extractors, percolation type extractors, screw type extractors, and auger type continuous extractors. Typical percolation solvent extraction methods include, for example, rotary deep bed, horizontal belt and continuous loop. In rotary deep bed extraction, a series of deep cells having a HOF bed of a depth up to about 5 meters are subjected to countercurrent extraction by fresh solvent and miscella. In horizontal belt extraction a shallow bed of HOF is conveyed through a series of solvent sprays in a countercurrent flow scheme. Continuous loop extractors are shallow-bed extractors that convey the HOF through an enclosed vertical loop in a countercurrent flow scheme. In each method, the miscella percolates through the bed and is collected for solvent removal/recycle and oil finishing. Useful solvents include, for example, hydrocarbons, alkanols and alkanol-containing aqueous solutions. Examples of suitable solvents include, but are not limited to, C₂₋₈ hydrocarbons, C₁₋₄ alkanols, and mixtures thereof. In one embodiment, the solvent is selected from methanol, ethanol, n-propanol, i-propanol, acetone and hexane. A HOF bed residence time (i.e., contact time) with the solvent of at least 10 minutes, at least 30 minutes, at least 45 minutes, or even at least 60 minutes is preferred.

In one process option, in an optional extraction method, supercritical carbon dioxide extraction can be used instead of organic solvent extraction. In this method, liquefied carbon dioxide is the solvent that is used to extract oil from a bed of HOF expandettes. After extraction, the liquid carbon dioxide and oil mixture is collected and depressurized. Upon depressurization, the carbon dioxide evaporates leaving the oil.

The HOF expandettes of the present invention preferably have a lab extractability, as measured by the Soxhlet method known in the art, of at least 75%, 80%, 85% or even 90%. Lab extractability is typically not a good indicator of how material will behave in industrial scale extractions where considerations of density and percolation rate of formed expandette beds can influence extraction efficiency. For example, powders may provide high lab extractability but are not capable of being process on an industrial scale because of poor solvent percolation rates. However, lab extractability is a good indicator of how much oil can be extracted under commercial conditions given adequate percolation rate. Based on experimental evidence to date, it has been determined that at least 75%, 88%, 85% or even 90% of the oil contained in the expandettes of the present invention can be extracted.

The HOF expandettes of the present invention are ideally suited for oil removal by solvent extraction without the risk of extractor plugging or drainage issues. The efficiency of HOF solvent extraction can be measured in a number of ways, and efficiency is generally a function of the combination of the contactable surface area, the permeability of the HOF expandettes, and the permeability, percolation rate, static holdup and dynamic holdup characteristics of the formed HOF expandette extraction bed. In one efficiency measure, the percolation rate of a HOF bed is determined. The percolation rate is the rate at which solvent flows through the bed. The percolation rate should be low enough to allow sufficient contact time to result in extraction of at least about 50, 55, 60, 65, 70, 75, 80, 85, 90 and even 95% of the oil contained in the HOF thereby resulting in a SEHOF oil content of less than 1.7 wt % (anhydrous basis), but should be high enough to prevent solvent holdup and carry over. Experimental evidence to date indicates that the expandettes of the present invention provide optimum extraction conditions of moderate percolation rates and some hexane pooling on top of the expandette bed. In one embodiment, a percolation rate of from about 0.02 to about 0.08 liters/cm²/minute, from about 0.028 to about 0.6 liters/cm²/minute, or even from about 0.04 to about 0.05 liters/cm²/minute is suitable for the practice of the present invention. It is believed that, as compared to expanded corn beds known in the art, the HOF expandette beds of the present invention exhibit a greater percolation rate that enables more efficient extraction of oil from a bed of HOF expandettes in commercial oil extraction processes, such as, for example, leach bed extraction. In particular, commercial scale extraction can be run at increased throughput rates enabling multi-pass and/or counter-current extraction schemes resulting in higher oil concentration in the miscella and/or lower residual oil in the finished product meal.

Extraction beds formed from HOF expandettes of the present invention have improved percolation rates and holdup as compared to HOF expandettes known in the art. In particular, a packed extraction bed formed from expanded HOF prepared according to the process described in Example 6 of WO 05/108533, was analyzed and found to provide a percolation rate of about 0.04 liters/cm²/minute.

Solvent Reclamation

As described in more detail in WO 05/108533, as depicted in FIG. 2, crude SEHOF (14) (i.e., SEHOF comprising a wetting quantity of solvent) is processed in desolventization operation (15) to yield SEHOF (16) and reclaimed solvent; miscella (11) is processed in desolventization operation (12) to yield corn oil (13) and reclaimed solvent. Solvent is reclaimed from the crude SEHOF and miscella using any typical method such as rising film evaporation, drying, flashing, or any combination thereof such as de-solventizer/toaster equipment known in the art. In general, heat is applied to the crude SEHOF and miscella to evaporate the solvent. The solvent is then condensed, collected, optionally dewatered, and recycled to the extractor. In one embodiment, solvent is removed from crude SEHOF in a desolventization/toaster apparatus in a two-step operation. In the first, predesolventization, step, crude SEHOF is typically heated to from about 65° C. to about 70° C. to remove about 10% to about 25% of the solvent. As described above, it is preferred that the expandette moisture concentration is less than 12% by weight in order to prevent crude SEHOF agglomerization in this step of the desolventization operation. In the second, sparging step, the heated crude SEHOF from the first step is typically sparged with low pressure steam for at least about 1 hour to a final temperature of about 70° C. to about 105° C. to generate SEHOF (i.e., desolventized crude SEHOF). Typically, at least about 90 wt %, 95 wt %, 96 wt %, 97 wt %, 98 wt % or 99 wt % of the solvent contained in crude SEHOF is removed and SEHOF typically has a moisture content of at least about 10 wt %, 11 wt %, 12 wt %, 13 wt %, 14 wt %, 15 wt %, 16 wt %, 17 wt % or even 18 wt %. In one embodiment for desolventizing miscella where an alkanol or its solution as an extractant, a miscella phase separation can be done by decreasing oil solubility as through means such as dilution, pH adjustment and/or cooling. The resulting phases can then be separated and the oil phase can be optionally distilled to remove alkanol. The alkanol phase can be re-concentrated, if required. In a corn oil processing plant containing an ethanol production operation, ethanol can be used as the HOF extraction solvent and re-concentration could be combined with ethanol separation from the fermentation liquor.

Desolventized miscella (13) (termed crude oil) can be stored and/or undergo further processing. Crude oil can be refined to produce a final oil product. Methods for refining crude oil to obtain a final oil are known to those skilled in the art. For example, Hui, Bailey's Industrial Oil and Fat Products, 5th Ed., Vol. 2, Wiley and Sons, Inc., pages 125-158 (1996), the disclosure of which is incorporated by reference, describes corn oil composition and processing methods. Crude oil isolated using the methods described herein is of high quality and can be further refined using conventional oil refining methods. The refining may include bleaching and/or deodorizing the oil or mixing the oil with a caustic solution for a sufficient period of time to form a mixture that is thereafter centrifuged to separate the oil.

The expanded HOF of the present invention enables an improvement in solvent recovery efficiency from wet (crude) SEHOF beds. In particular, as compared to prior art expanded corn beds, less solvent is carried over and must be stripped from the wet SEHOF thereby reducing energy requirements and increasing throughput through process equipment. Based on experimental evidence to date, it has been determined that the expanded HOF of the present invention reduces solvent carry over but up to about 25% as compared to prior art processes. Additionally, improved HOF expandette porosity enables greater solvent removal efficiency.

The expanded HOF of the present invention also enables an improvement, on a crude oil weight basis, in solvent recovery efficiency. In particular, as compared to prior art expanded corn beds, increased extraction efficiency and low static holdup yield miscella having high oil content. On a crude oil weight basis, less solvent must be stripped from the miscella thereby reducing energy requirements and increasing throughput through process equipment.

### Sehof Characterisitics

The SEHOF of the present invention comprises oil, protein, amino acids, starch, and neutral detergent fiber (“NDF”), with concentrations of those components reported on an anhydrous weight percent basis. The oil content is less than 1.7%, for example, about 1.6%, about 1.5%, about 1.4%, about 1.3%, about 1.2%, about 1.1%, about 1%, about 0.9%, about 0.8%, about 0.7%, about 0.6%, about 0.5%, about 0.4%, or even about 0.3%, and ranges thereof, is preferred. A protein content of about 9%, about 10% about 11, about 12%, about 13%, about 14%, about 15%, about 20% or even 25%, and ranges thereof, is preferred. A total lysine content of between about 0.4% and about 0.6%, for example, about 0.4%, 0.45%, 0.5%, 0.55% or 0.6% is preferred. A starch content of from about 30% to about 75%, from about 35% to about 75%, or even from about 40% to about 75% is preferred. A NDF content of about 12%, about 13%, about 14%, about 15%, about 16% about 18% or even about 24%, and ranges thereof, is preferred. A weight ratio of protein to starch of about 0.15, 0.16, 0.17, 0.18, 0.19, 0.2, 0.25, 0.3, 0.4, 0.5 or even 0.8, and ranges thereof, is preferred. In yet another embodiment, a ratio of SEHOF total lysine to total SEHOF protein of about 0.015, about 0.02, about 0.025, about 0.03, about 0.035, about 0.04, about 0.045, about 0.05, about 0.055 or about 0.06, and ranges thereof, is preferred. In another embodiment, a ratio of SEHOF tryptophan to total SEHOF protein of 0.007, 0.008, 0.009, 0.01, 0.011, 0.012, 0.013, 0.014 or 0.015, and ranges thereof, is preferred. SEHOF of the present invention also comprises acid detergent fiber (“ADF”) with concentrations of less than 3 wt %, 2.9 wt %, 2.8 wt %, 2.7 wt %, 2.6 wt %, 2.5 wt %, 2.4 wt %, 2.3 wt %, 2.2 wt %, 2.1 wt % or even 2 wt %, and ranges thereof, preferred.

In one embodiment, SEHOF comprising between about 9 wt % and about 25 wt % protein, between about 0.4 wt % and about 0.6 wt % total lysine, between about 12 wt % and about 24 wt % NDF, less than about 1.7 wt % oil and having a weight ratio of protein to starch of between about 0.15 and about 0.8 is provided.

Feed Rations

Animal feed rations having unique nutritional properties can be prepared from the SEHOF of the present invention yielding feed rations requiring reduced amounts of supplemental ingredients, such as proteins, amino acids and/or nutritional components.

Some animal diets comprise number two yellow corn as the main cereal source. In the case of swine dietary requirements, yellow number 2 may not provide sufficient dietary requirement amounts of the essential amino acids lysine and tryptophan, among others. Lysine and tryptophan supplements are typically added to yellow number 2 in the form of soybean meal, meat and bone meal, canola meal, wheat middlings, etc. and/or synthetic versions in order to meet the animal's essential amino acid requirements. It has been discovered that SEHOF prepared from yellow number 2 corn or corn having one or more improved traits including high oil, hard endosperm, high nutritional density, high protein, high starch, waxy corn and white corn, or a combination thereof, have an increased protein concentration, amino acid concentration and improved amino acid profile when compared to the whole corn from which the SEHOF was prepared. In particular, experimental evidence to date indicates that the concentration of various amino acids in the SHOF of the present invention is increased by 10%, 30%, 50%, 100%, 150% or even 200% as compared to yellow number two corn. It is believed that the improvement in the amino acid profile is at least partially a function of the corn variety and/or the fractionation process. In particular, in the fractionation process, the zein proteins of corn, which are low in lysine and tryptophan, are primarily associated with the LOF fraction that is separated from the HOF fraction. The increased protein and amino acid concentrations is also believed to be at least partially a function of the corn variety, the fractionation process and/or the improved expansion process that enables improved oil extraction efficiency by virtue of efficient oil removal. In one embodiment of the present invention, a ratio of SEHOF protein concentration to yellow number 2 protein concentration of at least 1.1, 1.2, 1.3, 1.4, 1.5, 1.6, 1.7, 1.8, 1.9, 2, 2.1, 2.2, 2.3, 2.4 or even 2.5 is preferred. In another embodiment, a ratio of SEHOF total lysine concentration to yellow number 2 total lysine concentration of at least 1.1, 1.2, 1.3, 1.4, 1.5, 1.6 or even 1.7 is preferred. In yet another embodiment, a ratio of SEHOF tryptophan concentration to yellow number 2 tryptophan concentration of at least 1.1, 1.5, 2, 2.5 or 3 is preferred. The higher concentration of essential amino acids in SEHOF leads to a reduction in the requirement for incorporation of essential amino acids from other sources into the feed.

As compared to SEHOF, yellow number two corn is also high in poly-unsaturated fats and contains significant levels of xanthophylls. High levels of poly-unsaturated fat in a swine diet may problematically lead to undesirable soft carcass fat. Xanthophylls may cause yellow carcass fat. Low xanthophyll concentration favors white carcass fat that is valued in some markets. A SEHOF xanthophyll concentration, on a weight percent basis, of about 15 mg/kg, about 14 mg/kg, about 13 mg/kg, about 12 mg/kg, about 11 mg/kg, about 10 mg/kg, about 9 mg/kg, about 8 mg/kg, about 7 mg/kg, about 6 mg/kg or about 5 mg/kg, and ranges thereof, is preferred.

It has further been discovered that the oil remaining in SEHOF has a higher ratio of oleic acid to linoleic acid than the extracted oil. Oleic acid is more saturated than is linoleic acid and promotes a firmer carcass fat in monogastric animals, such as pigs, therefore, as compared to yellow number 2, the SEHOF fatty acid ratio favors a firmer carcass fat. It is believed that the improvement is at least partially a function of the corn variety. It is further believed that the improvement is at least partially a function of increased oil extraction efficiency resulting from expansion improvements. In one embodiment, a ratio of oleic acid to linoleic acid of greater about 0.4, for example, 0.45, 0.5, 0.55, or even 0.60 is preferred.

Therefore the unique chemical and nutritional characteristics of the SEHOF of the present invention may provide some beneficial effects when replacing corn, such as yellow number 2, in animal diets. Those effects include a reduction in the amount of amino acid supplementation and a reduction in the use of additional protein sources to meet amino acid needs. Further, SEHOF provides a reduction in the potential for soft and yellow fat in animal carcasses.

SEHOF can be combined with other ingredients to produce animal feeds. Ingredients include, for example, vitamins, minerals, high oil seed-derived meal, meat and bone meal, salt, amino acids, feather meal, fat, oil-seed meal, corn, sorghum, wheat by-product, wheat-milled by-product, barley, tapioca, corn gluten meal, corn gluten feed, bakery by-products, full fat rice bran, rice hulls. The animal feed may be tailored for particular uses such as feed for poultry, swine, cattle, equine, aquaculture and pets, and can be tailored to animal growth phases.

### DEFINITIONS

As used herein, the terms “whole kernel” or “whole corn” refers to a kernel that has not been separated into its constituent components, e.g., the hull, endosperm, tip cap, pericarp, and germ have not been purposely separated.

“Plasticity” refers to the combination of expandette properties including the degree to which it maintains structural integrity, a low fines content of less that about 20% through 18 mesh, high porosity, and low complexation between starch and oil. Structural integrity can be measured by testing in a Model 2 Crown pilot extractor. Acceptable structure integrity results are generally determined that the extractor recirculation pump does not plug, drainage is acceptable to one skilled in the art and the residual oil in the expandettes is less than about 2.0 wt % or even less than about 1.5 wt %. The porosity, complexation and extractability can be determined as described in Aguilera et al., Laboratory and Pilot Solvent Extraction of Extruded High-Oil Corn, JOACS, 63(2):239-243 (1986).

“Fines” refers to particles that pass through a U.S. No. 18 sieve having a 1 mm opening (as defined in ASTME-11-61 specifications).

“Predominant” or “predominantly” means at least about 50%, preferably at least about 75% and more preferably at least about 90% by weight.

“Total lysine” refers to the sum of lysine contained in proteins and free lysine.

Having described the invention in detail, it will be apparent that modifications and variations are possible without departing from the scope of the invention defined in the appended claims.

### EXAMPLES

The following non-limiting examples are provided to further illustrate the present invention.

### Example 1

High oil corn was processed according to the process of the present invention wherein the corn was fractionated into LOF and HOF fractions in a ratio of LOF to HOF of about 64 to 36. The HOF fraction was conditioned to 14% moisture at 27° C. The conditioned HOF fraction was expanded at 30 bar and 150° C. to generate HOF expandettes. SEHOF was prepared from the HOF expandettes by extracting with hexane and desolventizing in a desolventizer/toaster apparatus at a first stage heating final temperature of 65° C. and a second stage steam stripping final temperature of 105° C. and a second stage residence time of about one hour. The SEHOF composition was analyzed with the results reported in Table 1 on an anhydrous basis. Also included in Table 1 is a typical composition of yellow #2 corn with concentrations reported in percent by weight on an anhydrous basis.

TABLE 1

| Component¹ | Yellow number 2 | SEHOF |
|---|---|---|
| Protein % | 8.3 | 12.46 |
| Fat % | 3.9 | 1.14 |
| Ash % | 1.2 | 2.90 |
| NDF % | 7.8 | 13.28 |
| ADF % | 2.0 | 2.56 |
| Starch % | 73.0 | 61.05 |
| Calcium % | 0.03 | 0.03 |
| Phosphorus % | 0.28 | 0.64 |
| Total Lysine % | 0.27 | 0.56 |
| Cysteine % | 0.21 | 0.28 |
| Isoleucine % | 0.29 | 0.40 |
| Methionine % | 0.19 | 0.25 |
| Threonine % | 0.29 | 0.45 |
| Tryptophan % | 0.06 | 0.11 |
| Valine % | 0.40 | 0.60 |
| Arginine % | 0.40 | 0.78 |
| Histidine % | 0.25 | 0.36 |
| Leucine % | 0.99 | 1.12 |
| Phenylalanine % | 0.41 | 0.52 |

¹SEHOF had moisture concentrations of 10.04%.

### Example 2

In a comparative example, a trial was conducted to determine the ash, Protein, ADF, NDF and oil content of SEHOF fractions prepared by the process described in WO 05/108533 Example 6 wherein HOF was expanded at a steam sparge rate to the expander barrel of 0.04 kg of steam per kg of HOF (i.e., a 4% rate), 36 bar pressure and 143° C. The expanded HOF was then extracted with hexane to yield SEHOF. Chemical compositions for SEHOF 1, SEHOF 2 and yellow number 2 are given in Table 2 below where percent moisture is reported, but the values in percent by weight for ash, protein, ADF, NDF and oil are reported on an anhydrous basis.

TABLE 2

| COMPONENT | SEHOF 1 | SEHOF 2 | Yellow number 2 |
|---|---|---|---|
| ASH % | 2.21 | 2.55 | 1.29 |
| MOISTURE % | 10.0 | 11.1 | 11.5 |
| PROTEIN % | 11.10 | 10.02 | 8.96 |
| ADF¹ % | 3.03 | 3.46 | 1.88 |
| NDF % | 14.58 | 13.00 | 8.00 |
| OIL % | 2.24 | 4.42 | 3.54 |

¹Acid Detergent Fiber

### Example 3

In a series of 15 trials, yellow number 2 corn was processed according to the process of the present invention wherein the corn was fractionated into LOF and HOF fractions in a ratio of LOF to HOF of about 65 to 35. The HOF fraction was conditioned to 14% moisture at 27° C. The conditioned HOF fraction was expanded at 30 bar and 150° C. to generate HOF expandettes. SEHOF was prepared from the HOF expandettes by extracting with hexane and desolventizing in a desolventizer/toaster apparatus at a first stage heating final temperature of 65° C. and a second stage steam stripping final temperature of 105° C. and a second stage residence time of about one hour. The SEHOF compositions were analyzed with the average results for the 15 individual trials, the associated standard deviation (STDEV) and minimum and maximum values are reported in Table 3 on a weight percent anhydrous basis wherein the SEHOF had an average moisture content of 14.1% and a range of values from 13.1% to 15.8% at a standard deviation of 0.92.

TABLE 3

| Component | Average | STDEV | MAXIMUM | MINIUM |
|---|---|---|---|---|
| Phytic acid | 1.82 | 0.057 | 2.06 | 1.74 |
| Phytate | 0.54 | 0.031 | 0.6 | 0.49 |
| phosphorus | | | | |
| ADF | 3.78 | 0.403 | 4.6 | 3.63 |
| Ash | 3.21 | 0.183 | 3.87 | 3.09 |
| Crude Protein | 12.11 | 0.392 | 12.97 | 11.51 |
| Fat | 1.12 | 0.500 | 3.02 | 0.59 |
| NDF | 15.74 | 1.415 | 19.1 | 12.47 |
| Insoluble fiber | 16.51 | 0.554 | 18.37 | 13.37 |
| Soluble fiber | 0.88 | 0.195 | 2.09 | 0.7 |
| Total digestible | 17.39 | 0.518 | 19.88 | 14.77 |
| fiber | | | | |
| Calcium | 0.08 | 0.034 | 0.15 | <0.02 |
| Chloride | 0.09 | 0.009 | 0.10 | 0.08 |
| Magnesium | 0.28 | 0.025 | 0.33 | 0.24 |
| Phosphorus | 0.69 | 0.024 | 0.73 | 0.62 |
| Potassium | 0.79 | 0.06 | 0.9 | 0.67 |
| Sodium | <0.02 | — | <0.02 | <0.02 |
| Sulfur (ppm) | 0.13 | 0.004 | 0.13 | 0.12 |
| Cobalt (ppm) | 1.16 | — | 1.16 | <1.16 |
| Copper (ppm) | 4.42 | 0.941 | 5.81 | 2.33 |
| Iron (ppm) | 116.7 | 26.9 | 179.1 | 68.6 |
| Manganese (ppm) | 14.4 | 1.056 | 17.4 | 12.8 |
| Molybdenum (ppm) | <1 | — | <1 | <1 |
| Zinc (ppm) | 55.2 | 5.501 | 66.3 | 47.7 |
| Dextrose | 0.67 | 0.036 | 0.7 | 0.62 |
| Fructose | 0.4 | 0.019 | 0.47 | 0.37 |
| Maltose | 0.41 | 0.031 | 0.47 | <0.2 |
| Sucrose | 3.22 | 0.299 | 4 | 2.6 |
| Lactose | <0.5 | — | <0.5 | <0.5 |
| Total Starch | 67.1 | 2.41 | 73.3 | 62.8 |
| Gel Starch | 76.2 | 3.6 | 84.9 | 69.8 |
| Alanine | 0.8 | 0.041 | 0.86 | 0.74 |
| Arginine | 0.75 | 0.046 | 0.84 | 0.7 |
| Aspartic Acid | 0.86 | 0.043 | 0.94 | 0.8 |
| Cysteine | 0.23 | 0.016 | 0.27 | 0.21 |
| Glutamic Acid | 1.86 | 0.099 | 2.06 | 1.69 |
| Glycine | 0.59 | 0.03 | 0.65 | 0.56 |
| Histidine | 0.36 | 0.025 | 0.41 | 0.31 |
| Hydroxylysine | 0.03 | 0.004 | 0.03 | 0.02 |
| Hydroxyproline | 0.04 | 0.012 | 0.058 | 0 |
| Isoleucine | 0.41 | 0.023 | 0.45 | 0.37 |
| Lanthionine | 0.01 | 0.011 | 0.03 | 0 |
| Leucine | 1.11 | 0.059 | 1.22 | 0.99 |
| Lysine | 0.52 | 0.032 | 0.57 | 0.48 |
| Methionine | 0.22 | 0.015 | 0.26 | 0.2 |
| Ornithine | 0.01 | 0.004 | 0.01 | 0 |
| Phenylalanine | 0.52 | 0.026 | 0.57 | 0.48 |
| Proline | 0.86 | 0.051 | 0.95 | 0.78 |
| Serine | 0.47 | 0.033 | 0.53 | 0.41 |
| Taurine | 0.07 | 0.011 | 0.09 | 0.06 |
| Threonine | 0.43 | 0.022 | 0.47 | 0.38 |
| Tryptophan | 0.1 | 0.01 | 0.12 | 0.08 |
| Tyrosine | 0.32 | 0.018 | 0.35 | 0.29 |
| Valine | 0.6 | 0.034 | 0.67 | 0.56 |
| Total Amino | 11.17 | 0.613 | 12.4 | 10.2 |
| Acids | | | | |

A second series of 15 SEHOF preparation trials was done according to the conditions described above. The SEHOF compositions were analyzed with the average results for the 15 individual trials, the associated standard deviation (STDEV) and minimum and maximum values are reported in Table 4 on a weight percent anhydrous basis wherein the SEHOF had an average moisture content of 14.5% and a range of values from 13.5% to 17% at a standard deviation of 1.41.

TABLE 4

| Component | Average | STDEV | MAXIMUM | MINIUM |
|---|---|---|---|---|
| Phytic acid | 1.93 | 0.08 | 2.08 | 1.77 |
| Phytate | 0.54 | 0.02 | 0.58 | 0.53 |
| phosphorus | | | | |
| ADF | 3.88 | 0.20 | 4.27 | 3.39 |
| Ash | 3.15 | 0.14 | 3.38 | 2.89 |
| Crude Protein | 12.16 | 0.26 | 12.62 | 11.73 |
| Fat | 0.69 | 0.18 | 1.01 | 0.34 |
| NDF | 16.36 | 1.53 | 20.62 | 13.82 |
| Insoluble fiber | 17.04 | 1.02 | 19.53 | 15.32 |
| Soluble fiber | 1.55 | 0.23 | 2.11 | 0.77 |
| Total digestible | 18.6 | 1.03 | 20.82 | 16.84 |
| fiber | | | | |
| Calcium | 0.07 | 0.02 | 0.11 | 0.07 |
| Chloride | 0.05 | 0.02 | 0.08 | 0.03 |
| Magnesium | 0.29 | 0.02 | 0.32 | 0.23 |
| Phosphorus | 0.58 | 0.04 | 0.64 | 0.48 |
| Potassium | 0.84 | 0.04 | 0.92 | 0.74 |
| Sodium | <0.02 | — | — | — |
| Sulfur (ppm) | 0.13 | 0.01 | 0.14 | 0.12 |
| Cobalt (ppm) | 1.25 | 0.26 | 2.33 | 1.17 |
| Copper (ppm) | 5.69 | 0.99 | 8.19 | 4.68 |
| Iron (ppm) | 95.7 | 27 | 161.4 | 65.5 |
| Manganese (ppm) | 15.04 | 1.83 | 19.88 | 12.87 |
| Molybdenum (ppm) | <1 | — | — | — |
| Zinc (ppm) | 60.12 | 5.36 | 72.51 | 51.46 |
| Dextrose | 0.4 | 0.03 | 0.44 | 0.35 |
| Fructose | 0.27 | 0.02 | 0.3 | 0.23 |
| Maltose | <0.5 | — | — | — |
| Sucrose | <0.2 | — | — | — |
| Lactose | 3.8 | 0.14 | 4.05 | 3.61 |
| Total Starch | 62.46 | 1.82 | 65.5 | 59.65 |
| Gel Starch | 64.09 | 1.48 | 66.67 | 61.99 |

### Example 4

A series of experiments were done to demonstrate the effect on expandette quality of differing total steam addition to HOF conditioning and expansion. The HOF was prepared from yellow number 2 corn.

Steam was added to the HOF in the conditioner and prior to introduction into the expander and into the barrel of the Buhler expander. A controller automatically controlled the conditioner temperature and steam addition rate to the expander as a percentage of the HOF rate. Samples of the expandettes were collected and tested for oil content, loose density, packed density, displacement density, pore volume, durability, and lab extractability. The following process conditions were monitored; expander knife drive amp load, expander amp load, expander die head position, extractor drainage, extractor miscella profiles, extractor level control variable frequency drive output. The extracted meal was also tested for oil content. The test conditions are summarized in Table 5 below where steam rate is reported as kg of steam per kg of HOF on a percentage basis.

TABLE 5

| | Conditioner | Expansion | Total | HOF feed Temp |
|---|---|---|---|---|
| Test | Steam Rate | Steam Rate | Steam Rate | (° C.) |
| C | 4.28 | 2.4 | 6.68 | 69.9 |
| B | 4.27 | 2 | 6.27 | 70 |
| A | 4.31 | 1.6 | 5.91 | 69.2 |
| D | 4.41 | 1 | 5.41 | 67.1 |
| E | 4.38 | 0.1 | 4.48 | 72.6 |
| F | 4.05 | 0.1 | 4.15 | 70 |

Sample sets A through E produced expandettes acceptable for extraction. Sample set F did not produce expandettes, but instead produced fines, and that particular set was not completed, although enough material was available to complete some of the laboratory tests listed above.

It was observed that over the course of the testing that HOF stream oil content increased. It is believed that the oil content increase was due to the performance in the fractionation equipment creating the HOF. However, it is believed that the HOF oil content range feeding the expander is within typical operating parameters. It is still further believed that the HOF oil content range in this testing had only a minor influence on the overall trends observed. The oil content in the HOF is listed in Table 6 below.

TABLE 6

| | Total Steam Addition | |
|---|---|---|
| Test | (kg steam/kg HOF) | HOF Oil Content (%) |
| C | 6.68 | 5.76 |
| B | 6.27 | 4.77 |
| A | 5.91 | 3.64 |
| D | 5.41 | 7 |
| E | 4.48 | 6.47 |
| F | 4.15 | 6.34 |

The physical description of the expandettes is given in Table 7 below.

TABLE 7

| | Total Steam Addition | | |
|---|---|---|---|
| Test | (kg steam/kg HOF) | Expandette size | Fine amount |
| C | 6.68 | Large | Minimum |
| B | 6.27 | Large | Minimum |
| A | 5.91 | Large | Minimum |
| D | 5.41 | Medium | Moderate |
| E | 4.48 | Medium | Moderate |
| F | 4.15 | Fines | All fines |

Overall, the expandette characteristics varied with steam addition rate. Sample sets C, B, and A produced expandettes that were very large chunks, and the stream had minimum amount of fines. These types of expandettes have been described with a consistency and shape similar to “corn chips.” Sample sets D and E created a product that was a mixture of expandettes and fines.

The expandettes were tested for loose density, packed density, displacement density, and pore volume. The samples had varying amounts of fines and chunks, which made representative sample collection difficult. To improve the testing accuracy, the loose density and packed density testing was done in duplicate by weighing approximately 150 grams of sample into a 500 ml graduated cylinder. The volume occupied was recorded and used to calculate the loose density. The graduated cylinder was tapped on the counter 100 times and the new volume recorded. This value was used to calculate the packed density. The results are presented in Table 8 in g/ml.

TABLE 8

| | | Loose | Loose | Packed | Packed |
|---|---|---|---|---|---|
| | Total Steam | Density | Density | Density | Density |
| Test | (%) | Test 1 | Test 2 | Test 1 | Test 2 |
| C | 6.68 | 0.37 | 0.38 | 0.39 | 0.42 |
| B | 6.27 | 0.35 | 0.34 | 0.37 | 0.38 |
| A | 5.91 | 0.35 | 0.38 | 0.38 | 0.4 |
| D | 5.41 | 0.38 | 0.4 | 0.43 | 0.44 |
| E | 4.48 | 0.37 | 0.4 | 0.41 | 0.44 |
| F | 4.15 | 0.46 | 0.47 | 0.54 | 0.54 |

The general trend indicates that the expandette density decreases with increasing steam feed rate, although there is not a strong correlation. For packed density, the high steam addition expandettes show minimal change in the density from the loose density values. Sample F, which was all fines increased in density the most from packing.

Displacement density was measured in a graduated cylinder by recording the change in volume of 200 ml of mineral oil after approximately 75 grams of expandette sample was added. Pore volume was measured as the weight of mineral oil taken up by a weighed amount of sample after 10 minutes of contact. Excess oil was removed by dabbing with a paper towel before weighing. The values listed in the table are cubic centimeters and were calculated using the weight increase and the density of the light mineral oil used. A density of 0.845 g/ml was used for the light mineral oil (light mineral oil has a density of 0.83-0.86 g/ml). Displacement density (in g/mL) and pore volume (in mL) are reported in Table 9.

TABLE 9

| Test | Total Steam (%) | Displacement Density | Pore Volume |
|---|---|---|---|
| C | 6.68 | 1.1 | 0.19 |
| B | 6.27 | 1.09 | 0.22 |
| A | 5.91 | 1.15 | 0.27 |
| D | 5.41 | 1.27 | 0.29 |
| E | 4.48 | 1.18 | 0.31 |
| F | 4.15 | 1.29 | 0.27 |

The data appear to indicate that the displacement density decreases as expander steam rate increases. The data generated during this does not appear to indicate a pore volume trend as the steam is increased to the expander.

The expandettes prepared in Tests A-E were tested for durability according to the method of McElhiney, Robert R. (ed.), Feed Manufacturing Technology III (1985). Expandette samples were screened through a #6 mesh Tyler standard screen by shaking the material back and forth 30 times. The expandettes retained on the screen were collected and a 500 gram sample (±10 grams) was placed in a tumbler compartment having dimensions of 30.5 cm×30.5 cm×12.7 cm. Each sample was tumbled for 10 minutes at 50 rpm. Each sample was then screened through a #6 mesh Tyler standard screen by shaking the material back and forth 30 times. The retained expandette and sieved fines were collected and weighed. The results are reported in Table 10 below where expandette durability is reported on a % retained basis.

TABLE 10

| Test | Total Steam (%) | % Retained |
|---|---|---|
| C | 6.68 | 86.1 |
| B | 6.27 | 85.3 |
| A | 5.91 | 86.6 |
| D | 5.41 | 69.5 |
| E | 4.48 | 67 |
| F | 4.15 | All fines - not tested |

The data shows a difference between tests C, B and A which tested near 86%, and test D and E, which tested below 70%. For commercial operation, the higher test values of samples C, B and A would hold up to mechanical conveying and other mechanical abrasion such as seals screws, better than the two lower test values of samples D and E. Generally, high quality commercial pellets are in the >90% retained range.

Expandette tests A-E were evaluated for lab scale oil extractability. For the extraction analysis, about 40 grams of expandettes were placed in a 25 mm-diameter glass chromatography column (ACE glass, Inc. Vineland, N.J.) having a Soxhlet thimble filter at the outlet to prevent fines from washing out of the column. Hexane was preheated to 55° C. and saturated with water (0.03 wt % at 55° C.) and fed to the column at a fixed rate of 30 ml/min using a peristaltic pump. Hot water was run through the jacket of the column to ensure a constant temperature of 55° C. during the extraction. Miscella fractions containing hexane and corn oil were periodically collected from the column and the volume and collection time were recorded. The miscella fractions were each transferred to a separate tared aluminum pan. Most of the hexane in the pan was evaporated using light stream of air or nitrogen. The pans were then transferred to an oven and dried at 105° C. for 30-60 minutes. The cooled pans were then weighed to determine the total amount oil collected. Extraction kinetics were determined by measuring the amount of oil extracted over time (evaporation of miscella). The total amount of oil in the flakes was determined by both conventional soxhlet hexane extraction (6 hrs) and the Swedish tube method (AOCS method Am 2-93). Lab extractability results are presented in Table 11.

TABLE 11

| Test | Total Steam (%) | Lab Extractability (%) |
|---|---|---|
| C | 6.68 | 52.7 |
| B | 6.27 | 51.3 |
| A | 5.91 | 79.5 |
| D | 5.41 | 85.5 |
| E | 4.48 | 89.2 |
| F | 4.15 | 95.4 |

The general observation from the data is that the extractability of oil from an expandette decreases as the amount of steam added to the expander increases. Note that although sample F provided the highest lab extractability, that material consists of fines which would be unsuitable for commercial scale extraction because the permeability of deep beds would not be great enough to be practical; solvent would pool at the bed surface and would not permeate through the bed at a commercially-practical rate. Therefore, tests D and E provide the optimum extractability and commercial scale throughput.

Expandette residual oil concentration versus miscella volume eluted from the column was evaluated and the results are reported in Table 12 below for Test C (6.68% total steam rate), Test B (6.28% total steam rate), Test A (5.88% total steam rate), Test D (5.28% total steam rate), Test E (4.6% total steam rate) and Test F (4.15% total steam rate) where expandette residual oil concentration is reported in weight percent and miscella volume in mL is reported in parenthesis following the oil concentration value. For example, the test C expandette contained 5.7 wt % oil after 2 ml of miscella had been eluted from the column.

TABLE 12

| Test C | | Test B | | Test A | | Test D | | Test E | | Test F | |
|---|---|---|---|---|---|---|---|---|---|---|---|
| 5.7 | (2) | 4.8 | (1) | 3.6 | (2) | 7 | (2) | 6.4 | (1) | 6.3 | (1) |
| 5.3 | (32) | 4.6 | (20) | 3.3 | (23) | 5.6 | (26) | 5 | (25) | 3.8 | (19) |
| 4.9 | (62) | 4.4 | (37) | 2.9 | (41) | 4.6 | (38) | 3.9 | (47) | 2.3 | (39) |
| 4.5 | (86) | 4.1 | (57) | 2.7 | (55) | 3.8 | (56) | 3.2 | (65) | 1.6 | (60) |
| 4.3 | (105) | 3.9 | (73) | 2.3 | (76) | 3.1 | (78) | 2.6 | (87) | 1.2 | (82) |
| 4 | (122) | 3.7 | (92) | 2.1 | (93) | 2.6 | (94) | 2.1 | (110) | 1 | (99) |
| 3.8 | (142) | 3.4 | (110) | 1.8 | (119) | 2.1 | (120) | 1.7 | (134) | 0.8 | (123) |
| 3.5 | (162) | 3.2 | (125) | 1.6 | (127) | 1.7 | (139) | 1.6 | (149) | 0.7 | (141) |
| 3.4 | (178) | 3 | (142) | 1.4 | (148) | 1.7 | (159) | 1.3 | (172) | 0.6 | (163) |
| 3.2 | (199) | 2.8 | (162) | 1.2 | (165) | 1.5 | (178) | 1.2 | (193) | 0.5 | (190) |
| 3.1 | (217) | 2.7 | (178) | 1.1 | (182) | 1.4 | (199) | 1 | (214) | 0.4 | (206) |
| 2.9 | (233) | 2.6 | (196) | 1 | (201) | 1.2 | (219) | 0.9 | (239) | 0.4 | (226) |
| 2.8 | (253) | 2.4 | (215) | 0.9 | (218) | 1.1 | (238) | 0.8 | (256) | 0.3 | (246) |
| 2.7 | (272) | 2.3 | (232) | 0.8 | (237) | 1 | (256) | 0.7 | (277) | 0.2 | (270) |
| 2.6 | (290) | 2.3 | (248) | 0.7 | (252) | 0.9 | (270) | 0.6 | (297) | 0.2 | (290) |

In each test, samples D and E demonstrated improvement in extraction performance over samples, C, B and A.

In another evaluation, the percent of oil remaining in the expandette was measured versus the volume of miscella eluted from the column. The percent of oil remaining was calculated according to the following equation:

((Xᵢₙᵢₜ−Xₑₓₜ)/Xᵢₙᵢₜ) (100)

where Xᵢₙᵢₜ is the total amount of extractable oil (as measured by the soxhlet method) expandette oil concentration before extraction and Xₑₓₜ is the weight of oil collected. The results are reported in Table 13 below for Test C (6.68% total steam rate), Test B (6.28% total steam rate), Test A (5.88% total steam rate), Test D (5.28% total steam rate), Test E (4.6% total steam rate) and Test F (4.15% total steam rate) where the extractable oil remaining in the expandette is reported in percent and total miscella volume in mL is reported in parenthesis. For example, the test C expandette contained 92% extractable oil after 32 ml of miscella had been eluted from the column.

TABLE 13

| | | | | | |
|---|---|---|---|---|---|
| Test C | Test B | Test A | Test D | Test E | Test F |

| | | | | | | | | | | | |
|---|---|---|---|---|---|---|---|---|---|---|---|
| 92% | (32) | 96% | (14) | 89% | (23) | 81% | (20) | 81% | (20) | 60% | (19) |
| 85% | (61) | 92% | (35) | 80% | (40) | 67% | (38) | 67% | (38) | 37% | (39) |
| 78% | (89) | 87% | (52) | 73% | (55) | 54% | (58) | 54% | (58) | 24% | (63) |
| 74% | (106) | 82% | (73) | 65% | (73) | 45% | (74) | 45% | (74) | 19% | (80) |
| 69% | (124) | 77% | (92) | 56% | (93( | 38% | (93) | 38% | (93) | 15% | (103) |
| 66% | (141) | 72% | (109) | 50% | (110) | 32% | (114) | 31% | (115) | 12% | (123) |
| 62% | (160) | 67% | (127) | 43% | (127) | 27% | (138) | 26% | (135) | 11% | (143) |
| 58% | (180) | 64% | (142) | 38% | (148) | 24% | (155) | 23% | (153) | 9% | (168) |
| 56% | (197) | 60% | (161) | 34% | (163) | 22% | (176) | 20% | (174) | 8% | (183) |
| 53% | (218) | 57% | (177) | 30% | (183) | 20% | (195) | 17% | (198) | 7% | (206) |
| 51% | (236) | 54% | (196) | 26% | (202) | 18% | (217) | 15% | (217) | 6% | (225) |
| 50% | (249) | 52% | (211) | 24% | (217) | 16% | (234) | 14% | (234) | 5% | (247) |
| 47% | (274) | 49% | (230) | 21% | (235) | 14% | (255) | 12% | (255) | 4% | (268) |
| 46% | (290) | 47% | (247) | 18% | (252) | 13% | (269) | 9% | (297) | 3% | (288) |

The data presented in tables 12 and 13 show that tests D and E demonstrated improvement in extraction performance over tests C, B and A. The test F finely powdered material would not be suitable for use in commercial scale extraction processes.

The ampere load of the expander and the knife drive in expansion tests A-E was monitored and reported in table 14. In expansion, mechanical force conveys the HOF through a die head that was maintained at a constant pressure of about 30 bar with a hydraulic pump. The act of conveying the HOF through the die head creates an amp load on the expander motor that was monitored and reported in table 14. A rotating set of cutting knives is used to cut the expandettes into a desired length as the collect leaves the die head; the amp load to the knife drive was likewise monitored and reported in table 14.

TABLE 14

| | Total | Knife Drive amp load | Expander amp load (% |
|---|---|---|---|
| Test | Steam (%) | (% of full load amps) | of full load amps) |
| C | 6.68 | 49.6 | 58.3 |
| B | 6.27 | 50.7 | 60.3 |
| A | 5.91 | 48.3 | 61.8 |
| D | 5.41 | 39 | 60.9 |
| E | 4.48 | 38.1 | 62.8 |
| F | 4.15 | not expanded | not expanded |

No significant change from the baseline amp load was noticed as the steam addition changed. During testing it was noted that as the steam addition increased it required more amps to cut the expandettes, indicating higher expandette strength.

The die head position was continuously monitored during expansion tests A-E. The die head position is a measurement of the distance the die head is from the end of the barrel. At the 0 mm position the die head gaps are approximately 5 mm in length. As the die head position moves out, the gap increases. Because the die head is maintained at a fixed pressure, the position varies, or “floats”, based on HOF material and rheological properties. Die head position for tests A-E is reported in table 15.

TABLE 15

| Test | Total Steam (%) | Die head position (mm) |
|---|---|---|
| C | 6.68 | 13 |
| B | 6.27 | 13.4 |
| A | 5.91 | 13 |
| D | 5.41 | 11.1 |
| E | 4.48 | 10.8 |
| F | 4.15 | not expanded |

This data indicate that as the steam addition increases the die head position increases (moves out). The result is a larger gap, which creates a larger expandette. The larger expandette is reflected in the bulk density noted earlier. As described more fully below, expandette size and density will influence the operation of the extractor.

The expandettes were fed to a Crown model II series 203 extractor. During extraction testing, observations of the drainage (i.e., percolation) of the hexane through the expandette bed were made and reported in table 16 below on a scale of 0 to 5. A 0 rating indicates that essentially all of the hexane pools on the top of the expandette bed and does not percolate through the bed. A rating of 5 indicates high percolation rates and no hexane pooling on the bed. Test F was not extracted because it was believed that the fine material would not provide material beds having adequate drainage.

TABLE 16

| | | Percolation rating (0 |
|---|---|---|
| Test | Total Steam (%) | to 5 scale) |
| C | 6.68 | 4 |
| B | 6.27 | 4 |
| A | 5.91 | 4 |
| D | 5.41 | 3 |
| E | 4.48 | 2.5 |
| F | 4.15 | not extracted |

The test C, B and A samples had very high percolation rates and minimal pooling on the top of the bed. The percolation rates decreased as the steam addition to the expander decreased. It is believed that this is due to the presence of more fines in the expandette bed. While a high percolation rate is desired for throughput considerations, the absence of pooling on the expandette bed indicates that there might be insufficient contact time between the hexane and expandettes to provide sufficient oil extraction. Optimum conditions are moderate percolation rates with some hexane pooling on top of the expandette bed. Samples D and E provided the optimum percolation rate.

The oil concentration in the full (i.e., finished) miscella from the extractor wash continuously monitored. The full miscella is generated in the last extraction stage and is transferred to the evaporation equipment to separate the oil from the hexane. The data is reported in table 17.

TABLE 17

| Test | Total Steam (%) | Full miscella concentration (% oil) |
|---|---|---|
| C | 6.68 | 4.45 |
| B | 6.27 | 4.57 |
| A | 5.91 | 5.63 |
| D | 5.41 | 7.7 |
| E | 4.48 | 10.18 |
| F | 4.15 | not extracted |

The data show that as the steam addition to the expander increases, the amount of oil in the hexane at the last extraction wash stage decreases.

The residual oil content in the solvent extracted high oil fraction (“SEHOF”) leaving the extractor was measured and reported in table 18 along with the initial expandette oil content (wt %), and percentage of oil extracted from the expandettes.

TABLE 18

| | Total | Initial oil | SEHOF oil | % oil extracted |
|---|---|---|---|---|
| Test | Steam (%) | content (wt %) | content (wt %) | from expandettes |
| C | 6.68 | 5.76 | 1.89 | 67.2 |
| B | 6.27 | 4.77 | 1.46 | 69.4 |
| A | 5.91 | 5.14 | 1.08 | 79 |
| D | 5.41 | 7 | 0.76 | 89.1 |
| E | 4.48 | 6.47 | 0.72 | 88.9 |
| F | 4.15 | not extracted | not extracted | not extracted |

The results indicate that as the steam addition to the expander increases the residual oil left in the meal also increases. This results in lower extraction yields with increasing steam addition. The miscella profiles and this residual oil data indicate that higher steam addition rates are decreasing the ability to extract the oil from the expandettes. The data collected from the pilot plant agrees with the laboratory scale extractability data.

The example 4 data indicates that the expander requires a minimum amount of steam to form an expandette. Under the expansion conditions of test F (a steam addition rate of 4.15 kg of steam per 100 kg of HOF (i.e., 4.15%)), expandettes were not generated and the HOF was in the form of powder and fines. Tests D and E, with steam addition rates of 5.41% and 4.48%, respectively, produced expandettes with a mixture of fines. Tests C, B and A produced large expandettes with minimal fines. Because of the combination of high extractability and high throughput, the operating conditions of tests D and E are generally preferred. Based on experimental evidence to date, it is believed that as the maximum HOF oil content increases above about 7 wt %, such as in HOF prepared from high oil corn, the minimum amount of steam required to form an expandette will increase.

In view of the above, it will be seen that the several objects of the invention are achieved and other advantageous results attained.

As various changes could be made in the above compositions and processes without departing from the scope of the invention, it is intended that all matter contained in the above description and shown in the accompanying drawings shall be interpreted as illustrative and not in a limiting sense.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

What is claimed is:

1. An extracted corn fraction composition prepared from corn kernels, the extracted corn fraction comprising starch and, on an anhydrous basis, about 9 to about 25 weight percent protein, about 12 to about 24 weight percent neutral detergent fiber, and less than 1.7 weight percent oil, wherein the weight ratio of protein to starch is from about 0.15 to about 0.8.

2. The extracted corn fraction composition of claim 1 comprising between about 0.3 and about 1.7 weight percent oil.

3. The extracted corn fraction composition of claim 1 further comprising from about 0.4 to about 0.6 weight percent total lysine on an anhydrous basis.

4. The extracted corn fraction composition of claim 1 wherein the corn kernels are yellow number two corn.

5. The extracted corn fraction composition of claim 1 wherein the corn kernels are high oil corn kernels.

6. A corn expandette prepared from corn kernels, the expandette comprising oil, wherein the expandettes have a packed density of from about 0.3 to about 0.5 grams per milliliter.

7. The corn expandette of claim 6 having a displacement density of from about 1 to about 1.3 grams per milliliter.

8. The corn expandette of claim 6 having a laboratory oil extractability of at least 70%.

9. The corn expandette of claim 6 wherein the corn kernels are yellow number two corn kernels.

10. The corn expandette of claim 6 wherein the corn kernels are high oil corn kernels.

11. A process for preparing corn expandettes, the process comprising
(i) fractionating corn kernels into a high oil fraction and a low oil fraction, the high oil fraction having an oil content greater than the corn kernels and the low oil fraction having an oil content less than the corn kernels,
(ii) separating the high oil fraction from the low oil fraction, and
(iii) expanding the high oil fraction with steam in an expander to produce expandettes,
wherein the steam feed rate to the expander is from about 0.042 to about 0.075 kilograms of steam per kg of high oil fraction and the temperature of the high oil fraction in the expander is from about 140° C. to about 180° C.

12. The process of claim 11 wherein the expander pressure is regulated from about 26 to about 35 bar.

13. The process of claim 11 wherein the high oil fraction has an oil content of less than about 10.5 percent by weight on an anhydrous basis, the high oil fraction is conditioned prior to expansion, the steam feed rate to the high oil fraction conditioner is from about 0.03 to about 0.05 kilograms of steam per kilogram of high oil fraction, and the steam feed rate to the expander is from about 0.001 to about 0.03 kilograms of steam per kilogram of high oil fraction.

14. The process of claim 11 wherein the high oil fraction has an oil content of greater than about 10.5 percent by weight on an anhydrous basis and the temperature of the high oil fraction in the expander is from about 150° C. to about 165° C.

15. The process of claim 11 wherein the high oil fraction has an oil content of greater than about 10.5 percent by weight on an anhydrous basis, the high oil fraction is conditioned prior to expansion, the steam feed rate to the high oil fraction conditioner is from about 0.001 to about 0.02 kilograms of steam per kilogram of high oil fraction, and the remainder of the steam is added to the expander barrel.

16. The process of claim 11 wherein the high oil fraction is conditioned to a moisture content of at least 12 percent by weight prior to expansion.

17. The process of claim 11 wherein the high oil fraction is conditioned to a temperature of from about 60° C. to about 80° C. prior to expansion.

18. The process of claim 11 wherein oil is extracted from the expandettes with at least one solvent to prepare an extracted corn fraction.

19. The process of claim 18 wherein the expandettes are dried to less than about 12 percent by weight water prior to extraction.

20. The process of claim 18 wherein the extraction solvent is an organic solvent or carbon dioxide.

21. The process of claim 18 wherein at least about 80 percent of the oil in the expandette is extracted.

22. A method for formulating an animal food ration, the method comprising (i) determining the lysine and protein requirements of the animal, (ii) identifying a plurality of natural and/or synthetic feed ingredients and the available lysine and protein of each of the ingredients wherein one of the ingredients is a fractionated corn portion having a total lysine concentration greater than yellow number two corn and a ratio of total lysine to total protein of from about 0.015 to about 0.06, and (iii) formulating the ration from the identified ingredients to meet the determined lysine requirements of the animal.

23. The method of claim 22 wherein the fractionated corn portion is expanded at a temperature of from about 140° C. to about 180° C.

24. The method of claim 23 wherein the expanded fractionated corn portion is extracted.

25. The method of claim 22 further comprising (i) determining the tryptophan requirements of the animal, (ii) identifying a plurality of natural and/or synthetic feed ingredients and the available tryptophan of each of the ingredients wherein one of the ingredients is a fractionated corn portion having a tryptophan content greater than yellow number two corn, and (iii) formulating the ration from the identified ingredients to meet the determined tryptophan requirements of the animal, wherein the fractionated corn portion has a ratio of tryptophan to total protein of at least from about 0.009 to about 0.015.

26. The method of claim 25 wherein the fractionated corn portion is expanded at a temperature of from about 140° C. to about 180° C.

27. The method of claim 26 wherein the expanded fractionated corn portion is extracted.
